(19) United States
(12) Patent Application Publication
(10) Pub. No.: US 2008/0263612 A1
(43) Pub. Date: Oct. 23, 2008

(54) Audio Video Synchronization Stimulus and Measurement

(76) Inventor: J. Carl Cooper, Incline Village, NV (US)

Correspondence Address: Stevens Law Group, 1754 Technology Drive, Suite #226, San Jose, CA, 95110, US

(21) Appl. No.: 12/020,411

(22) Filed: Jan. 25, 2008

Related U.S. Application Data
(60) Provisional application No. 60/925,261, filed on Apr. 18, 2007.

(51) Int. Cl. H04N 7/173

(52) U.S. Cl. 725/116

(57) ABSTRACT

The present invention uses artificially generated unobtrusive audio and video synchronization events, which are essentially undetectable by normal human viewers, to send audio and video synchronization information by encoding audio and video events in normal program audio and video datastreams. By proper generation of unobtrusive audio and video synchronization events, and by proper use of modern electronics and software to automatically extract such unobtrusive synchronization events from audio and video signals, audio and video synchronization can be nearly continually provided, despite many rapid shifts in cameras and audio sources, without generating obtrusive events that distract the viewer or detract from the actual program material. At the same time, because such unobtrusive synchronization signals can be carried by standard (preexisting) audio and video transmission equipment, the improved unobtrusive synchronization technology of the present invention can be easily and inexpensively implemented because it is backward compatible with the large base of existing equipment.

### RELATED U.S. APPLICATION DATA

The present application is a non-provisional application, and claims the priority benefit of, U.S. Provisional Application No. 60/925,261, filed Apr. 18, 2007. The present application is also related to U.S. non-provisional patent application Ser. No. TBD, Entitled Audio Video Synchronization Stimulus and Measurement, filed on Jan. 25, 2008, concurrently with the present application.

### BACKGROUND OF THE INVENTION AND PRIOR ART

In modern television, movie and other entertainment systems, frequent problems arise because of unequal audio and video signal processing, and also because of transmission delays between the program origination point and the program reception point(s). Such variable transmission delays between the audio and video components of a program can lead to loss of lip synchronization, and other annoying discrepancies between the audio and video components of the signal. These discrepancies have become more and more complex and varied as the methods of processing and transmission have evolved.

A close time alignment between the audio and video components of a program is necessary in order for an audiovisual program to appear realistic. In order to maintain the appearance of proper lip synchronization, it has been observed by the Advanced Television Standards Committee (ATSC) Implementation Subcommittee that the audio components of a signal should not lead the video portions of a signal by more than about 15 milliseconds, and should not lag the video portion of the signal by more than about 45 milliseconds. These amounts have been reflected in the ATSC Implementation Subcommittee Finding IS-191 (26 Jun., 2003) “Relative Timing of Sound and Vision for Television Broadcast Operations”.

Many different approaches to maintaining, measuring and correcting audio and video timing at various points in various broadcast video systems are known, but all have drawbacks. These systems generally have some type of characteristic or nature that relies on the particular processing, storage and transmission methods and signals which are utilized. Accordingly, as the processing and transmission methods change, these prior art methods must be changed as well. Such changes frequently require the invention of new methods or improvements.

In the movie industry, clapboards have been utilized for decades for audio-video synchronization purposes. The clapboard is used at the start of filming for each scene to set a time common time point in the audio recorder and film camera. In practice, the clapboard is held in front of the film camera by an assistant, and the assistant causes a hinged mechanical flap to quickly slap closed, creating a “clap” sound. The clap is picked up by a microphone, and both the film camera and the audio equipment record the visual and audio components of the “clap” respectively. During subsequent film editing operations, the film editor can quickly align the film from the camera (image) and the film audio track carrying the sound (via magnetic or optical stripe or separately recorded) at the beginning of each recorded scene. A similar system is often utilized in television production as well.

Note that unlike many other prior art audio to video synchronization systems, the clapboard is added to the video signal optically (e.g. it is viewed by the camera) rather than electronically (e.g. being added to a video signal which is obtained from a camera). Similarly the audio “clap” is added to the audio signal audibly (e.g. it is a sound picked up by the microphone) rather than electronically (e.g. added to the audio signal which is obtained from the microphone). How the timing related signal is added to the audio and video is an important consideration in some embodiments of the present invention. Note that as used herein, program audio is intended to mean that portion of the audio signal that is the audible portion of the program (e.g. from the microphone) and program video is intended to mean that portion of the video signal that is the visual portion of the program (e.g. from the camera) as compared to non audio and video portions of the audio and video signals, for example such as synchronizing information. When speaking of adding, inserting, combining or otherwise putting together unobtrusive events and program audio and/or video it is intended that the unobtrusive event be carried with the audible and/or visual part of the program respectively. It is noted that an unobtrusive event may also be carried with a non-program audio or video part or with both program and non-program parts (as compared to being carried exclusively in the program audio or video) if the context of the wording so indicates.

Unfortunately, the clapboard system is obtrusive to the recording and transmission process. Viewers of the material are well aware of the clapboard's presence as it affects the content, and this detracts from the actual program material that is being transmitted or recorded. Thus the clapboard system is only used in the editing of programming but is unsuitable for inclusion during the filming, video recording or live transmission of the actual program.

Another system that is utilized in television systems involves electronically generating pop/flash signals. Here, a sound signal with a popping sound, tone burst or other contrasting audio signal and a video signal with a flash of light or other contrasting signal are simultaneously created. Variations of this system utilize specialized video displays, for example such as a stopwatch type of sweeping hand or a similar electronically generated sweeping circle with a corresponding sound which is generated as the visual sweep passes a known point. These specialized test signals are utilized alone, i.e. they replace the normal programming. The audio pop or tone and video flash or sweep are clearly discernable to the viewer, owing to their intended contrasting nature, e.g. they are intended to be specialized test signals. The specialized test signals are coupled and maintained through the video transmission and processing system (in place of video from the camera and audio from the microphone) to a measuring location. There, an oscilloscope or other instrument is utilized to measure the relative timing of the video flash and sound pop, and this information is used to do audio-visual synchronization.

Like the clapboard, the pop/flash system is unsuitable for inclusion during the filming, video recording or live transmission of the actual program. Also, like the clapboard system, the pop/flash system is very obtrusive in that viewers of the material are well aware of the pop/flash. This also detracts from the program material that is being transmitted.

One prior art audio video synchronizing system which utilizes contrasting video and audio test signals is described in U.S. Pat. No. 7,020,894 to Godwin, et al. As described in the Abstract: “The video test signal has first and second active picture periods of contrasting states. The audio test signal has first and second periods of contrasting states. As generated, the video and audio test signals have a predetermined timing relationship—for example, their changes of respective states may be coincident in time. At the receiving end of the link, the video and audio test signals as received are detected, and any difference of timing between the video and audio test signals is derived from their changes of respective states, measured and displayed, including an indication of whether the video signal arrived before the audio signal or vice-versa.”.

Another prior art audio video synchronizing system is shown in U.S. Pat. No. 6,912,010 to Baker which the Abstract describes as: “An automated lip sync error corrector embeds a unique video source identifier ID into the video signal from each of a plurality of video sources. The unique video source ID may be in the form of vertical interval time code user bits or in the form of a watermark in an active video portion of the video signal. When one of the video signals is selected, the embedded unique video source ID is extracted. The extracted source ID is used to access a corresponding delay value for an adjustable audio delay device to re-time a common audio signal to the selected video signal. A look-up table may be used to correlate the unique video source ID with the corresponding delay value.”

Yet another prior art audio video synchronizing system is shown in U.S. Pat. No. 6,836,295, which the Abstract describes as: “[t]he invention marks the video signal at a time when a particular event in the associated audio occurs. The mark is carried with the video throughout the video processing. After processing the same event in the audio is again identified, the mark in the video identified, the two being compared to determine the timing difference therebetween.”.

U.S. Pat. No. 4,313,135 compares relatively undelayed and delayed versions of the same video signal to provide a delay signal. This method requires connection between the undelayed site and the delayed site and is unsuitable for environments where the two sites are some distance apart. For example where television programs are sent from the network in New York to the affiliate station in Los Angeles, such system is impractical because it would require the undelayed video to be sent to the delayed video site in Los Angeles without appreciable delay, somewhat of an oxymoron when the problem is that the transmission itself creates the delay which is part of the problem. A problem also occurs with large time delays such as occur with storage such as by recording since by definition the video is to be stored and the undelayed version is not available upon the subsequent playback or recall of the stored video.

U.S. Pat. Nos. 4,665,431 and 5,675,388 show transmitting an audio signal as part of a video signal so that both the audio and video signals experience the same transmission delays, thus maintaining the relative synchronization therebetween. This method is expensive for multiple audio signals, and the digital version has proven difficult to implement when used in conjunction with video compression such as MPEG.

U.S. Reissue Pat. RE 33,535, corresponding to U.S. Pat. No. 4,703,355, shows in the preferred embodiment, encoding a timing signal in the vertical interval of a video signal and transmitting the video signal with the timing signal. Unfortunately many systems strip out and fail to transmit the entire vertical interval of the video signal, thus causing the timing signal to be lost. The patent also suggests putting a timing signal in the audio signal, which is continuous, thus reducing the probability of losing the timing signal. Unfortunately it is difficult and expensive to put a timing signal in the audio signal in a manner which ensures that it will be carried with the audio signal, is easy to detect, and is inaudible to the most discerning listener.

U.S. Pat. No. 5,202,761 shows to encode a pulse in the vertical interval of a video signal before the video signal is delayed. This method also suffers when the vertical interval is lost.

U.S. Pat. No. 5,530,483 shows determining video delay by a method which includes sampling an image of the undelayed video. This method also requires the undelayed video, or at least the samples of the undelayed video, be available at the receiving location without significant delay. Like the '135 patent above, this method is unsuitable for long distance transmission or time delays resulting from storage.

U.S. Pat. No. 5,572,261 shows a method of determining the relative delay between an audio and a video signal by inspecting the video for particular sound generating events, such as a particular movement of a speaker's mouth, and determining various mouth patterns of movement which correspond to sounds which are present in the audio signal. The time relationship between a video event such as mouth pattern which creates a sound, and the occurrence of that sound in the audio, is used as a measure of audio to video timing. This method requires a significant amount of audio and video signal processing to operate.

U.S. Pat. No. 5,751,368, a CIP of U.S. Pat. No. 5,530,483, shows the use of comparing samples of relatively delayed and undelayed versions of video signal images for determining the delay of multiple signals. Like the '483 patent, the '368 patent requires that the undelayed video, or at least samples thereof, be present at the receiving location. At column 6, lines 14-28, the specification teaches: “[a]lternatively, the marker may be associated with the video signal by being encoded in the active video in a relatively invisible fashion by utilizing one of the various watermark techniques which are well known in the art. Watermarking is well known as a method of encoding the ownership or source of images in the image itself in an invisible, yet recoverable fashion. In particular known watermarking techniques allow the watermark to be recovered after the image has suffered severe processing of many different types. Such watermarking allows reliable and secure recovery of the marker after significant subsequent processing of the active portion of the video signal. By way of example, the marker of the present invention may be added to the watermark, or replace a portion or the entirety of the watermark, or the watermarking technique simply adapted for use with the marker.”

Other prior art audio/video synchronization methods have relied upon natural coincidences in timing between audio and video signals. One example is the coincidence in timing between a mouth opening and the generation of a corresponding sound. Although less obtrusive than the above methods, these natural synchronization methods depend upon chance events rather than more reliable automatic timing methods and are therefore not always reliably available. For example, if a quiet scene were being filmed, no natural synchronization between audio and video would necessary occur, and thus relative audio and video timing would be difficult to ascertain.

A prior art system is shown in U.S. Pat. No. 5,387,943 to Silver, which in the Abstract describes “[a]n area of the image represented by the video channel is defined within which motion related to sound occurs. Motion vectors are generated for the defined area, and correlated with the levels of the audio channel to determine a time difference between the video and audio channels. The time difference is then used to compute delay control signals for the programmable delay circuits so that the video and audio channels are in time synchronization.”.

Generally, all of the prior art systems are either unsuitable for use during the actual program, or else depend upon chance coincidence of audio and video signals, and thus suffer from less than ideal reliability. Thus all prior art methods are still unsatisfactory to some extent.

Although less than ideal, prior art obtrusive audio and video synchronization methods were practiced by the industry, but they relied heavily upon audio-video engineers. These technicians needed to manually observe these events, determine proper audio and video timing adjustments, and then edit out the synchronization events from the audio and video ultimately displayed to end users. These methods are still widely used today, because they were originally developed in the early days of the film industry, were carried forward into the early days of the television industry, and have became deeply engrained into standard audio and video production art. However, in the modern era, where many cameras may be used and programs cut between many audio and video sources in a rapid manner, these obtrusive prior art synchronization methods have become increasingly unsatisfactory.

Ideally, what is needed is a way to unobtrusively (i.e. not undesirably noticeable or blatant, inconspicuously, not readily noticed or seen, keeping a low profile) insert audio and video synchronization signals (events) in audio and video streams that are unobtrusive or undetectable to the viewers of the program material, yet occur in a frequent and predictable manner. As will be seen, the invention provides a device, system and methods that overcomes these previously discussed problems in the prior art.

### BRIEF DESCRIPTION OF THE DRAWINGS

FIG. 1 shows a prior art system that detects natural (mouth-movement sound correlation) or obtrusive (pop/flash or clapper) events in audio and video signals, and determines the relative timing between these events.

FIG. 2 shows one embodiment of the invention utilized for placing corresponding events in program audio and video signals.

FIG. 3 shows an improved system configured according to the invention that detects unobtrusive events in audio and video signals and determines the relative timing between these events.

FIG. 4 shows a method of placing a corresponding unobtrusive event in video signals or alternatively in a video scene, according to the invention.

FIG. 5 shows a device for placing unobtrusive corresponding video and audio events in an audio and video program configured according to the invention.

FIG. 6 shows the use of the FIG. 5 device in the recording of a program.

FIG. 7 shows the use of the FIG. 2 device in the recording of a program.

FIG. 8 shows an improved system configured according to that one embodiment of the invention detects unobtrusive events in audio and video signals, determines the relative timing between these events, and then conceals the unobtrusive events.

### DETAILED DESCRIPTION OF THE INVENTION

As taught herein in respect to the preferred embodiment, an automated electronic system is used to perform sophisticated pattern analysis on audio and video signals, and automatically recognize even extremely small, minor, or unobtrusive patterns that may be present in such audio and video signals.

According to the invention, although obtrusive synchronization methods are deeply engrained in standard film and television industry art, such obtrusive methods are no longer necessary and may be replaced with the present invention. The present invention allows much smaller and in fact nearly imperceptible signals to be automatically detected in audio and video data with high degrees of reliability. As a result, more sophisticated unobtrusive video synchronization technology such as that provided by the invention is now possible.

The preferred embodiment teachings herein show one of ordinary skill in the art to generate unobtrusive audio and video synchronization events, and with the use of modern computer assisted audio and video data analysis methods, unobtrusive synchronization signals can be inserted into audio and video signals whenever needed. These synchronization signals or other events can be used to maintain lip synchronization audio and video synchronization, such as lip synchronization, despite many rapid shifts in cameras and audio sources.

According to the preferred embodiment invention, because the improved synchronization methods are unobtrusive, they can be freely used without the fear of annoying the viewer or distracting the viewer from the final video presentation. At the same time, the novel unobtrusive synchronization signals of the invention can be carried by standard and preexisting audio and video transmission equipment. As a result, the improved unobtrusive synchronization technology of the invention can be easily and inexpensively implemented because it is backward compatible with the current and future large base of existing equipment and related processes.

As previously discussed, the present invention differs from prior art audio video synchronization techniques in that the present invention relies on artificial (synthetic) but unobtrusive synchronized audio and visual signals, embedded as part of the normal audio/video program material. Since obtrusive synchronized audio and visual signals produced by obtrusive devices such as clappers and electronic pop/flash signals are known, the differences between obtrusive and unobtrusive audio visual synchronization methods as utilized in devices, systems and methods configured according to the invention will be discussed in more detail.

As discussed in the background, prior art “obtrusive” audio and visual synchronization methods generated audio and visual signals that dominated over the other audio and visual components of the program signal. Prior art clapboards had distinctive visual patterns and filled nearly all pixel elements of the image. Prior art flash units also filled nearly all pixel elements of the image. Prior art clapboards generated a sharp pulse “clap” that for a brief period represented the dominant audio wave intensity of the program signals, and prior art pop/flash units also generated a sharp “pop” that for a brief period represented the dominant audio wave intensity of the program signals.

A human viewer viewing such a prior art obtrusive audio or visual event could not fail to notice it. It would likely obscure or interrupt the program information of interest. Also, frequent repetition of audio and video events, which would be required for good audio and video synchronization, would rapidly become very annoying.

By contrast, the goal of an unobtrusive audio or video event marker configured according to the preferred embodiment of the invention is to generate an audio or video signal that neither obscures program information of interest, nor indeed would even be apparent to the average viewer who is not at least specifically looking for the audio or video event marker. Thus, an unobtrusive audio or video event marker does not necessarily need to be completely undetectable to the average human viewer (although in a preferred embodiment, it in fact would be undetectable), but should at least create a low enough level of distortion of or impact to the underlying audio or video signal so as to be almost always dismissed or ignored by the average viewer as random background audio or video “noise” as interpreted by the entity providing the program.

In order to do this, the visual part of an unobtrusive audio and visual synchronization method or device should either use only a small number of video screen pixels, or alternatively only make a minor adjustment to a larger number of video screen pixels. Similarly the audio part of an unobtrusive audio and visual synchronization method or device should either make a minor alteration to the energy intensity of a limited number of audio wavelengths, or alternatively make an even smaller alteration to the energy intensity of a larger number audio wavelengths. In either event, the key criterion for the system to remain unobtrusive is that it should preserve the vast majority of the program information that is being recorded or transmitted, and not annoy average viewers with a large number of obvious audio video synchronization events.

Although the exact cutoffs between obtrusive and non-obtrusive events are a function of human senses and physiology, and are best addressed by direct experimentation, some guidelines can be made, because some events are clearly detectable, and some events are clearly undetectable. However, it will be appeared to those skilled in the art that different applications will have different parameters and requirements. Thus, the actual boundaries that define obscure versus non-obscure will vary.

As his own lexicographer, in the present specification with respect to the teachings of the preferred embodiment and in the claims, the inventor defines obtrusive as “undesirably noticeable” as determined by the entity providing, and relative to, the particular program information of interest. Unobtrusive and not obtrusive are defined as not undesirably noticeable by that entity. For example in a television audio or video program obtrusive is meant to mean undesirably noticeable to the entity providing that program to another entity or viewer. The entity providing the program for example would be the production company making the program, the network distributing the program or the broadcaster broadcasting the program. It is of course entirely possible that each such entity could perceive a different level of event or different event as constituting obtrusive for different situations. For example the same or different entities could perceive obtrusive differently for a given program or program use, or the same entity could perceive a different level of event as constituting obtrusive for different programs, program uses, program types, program audiences or program distribution methods. Such different perceived levels merely constitute a different acceptable level of performance in practicing the invention with respect to different program types, programs and/or entities. The practice of the invention accordingly may be modified and tailored to suit a particular application and desired level of performance without departing from the teachings (and claimed scope) herein.

As a rough guideline, a video synchronization marker or event that affects less than 1% of the video pixels in an image, thus preserving greater than 99% of the pixels in an unaltered state, will be considered to be unobtrusive for purposes of illustrations only. Similarly, a video synchronization marker or event that affects more than 1% of the pixels in an image, but that only makes a change in any of the color levels or intensity levels of the pixels of 1% or less, will also be considered to be unobtrusive, again, for purposes of illustrations only.

The audio threshold for determining “unobtrusive” is somewhat different, possibly because the human ear is sensitive to audio sounds on a logarithmic scale. For illustration, normal conversation occurs with a sound intensity of about 50 to 65 decibels, whispers occur with an intensity of about 30 decibels, and barely audible sounds have an intensity of about 20 decibels. By contrast normal breathing, which is usually inaudible, has an intensity of about 10 decibels. Thus, again for illustration, an unobtrusive audio event may be considered to be an event of brief duration and barely audible with a power of about 30 decibels or under, occurring at one or more defined wavelengths somewhere in the normal range of human hearing, which is generally between 20 and 20,000 Hz, depending on an individual's hearing ability.

As an observation, the smaller the number of pixels affected, or the smaller the change in pixel values, or the smaller the number of audio wavelengths affected, or the smaller the change in average audio energy, the less obtrusive the event. Thus, although less than a 1% pixel change or 30 dB change maybe considered to be a range amount of change for a video or an audio synchronization event to be unobtrusive, still smaller amounts of change are better, less obtrusive. Thus, unobtrusive levels with 0.5%, 0.25% or less of changes in pixel levels or pixel intensity, and unobtrusive levels of 20 dB, 10 dB or less in sound wavelengths, or sound power levels maybe preferred. Ideally, for the unobtrusive audio and visual synchronization methods and devices configured according to the invention, the minimum change consistent with conventional reliable transmission or recording and subsequent detection is desired. Additionally, as transmission, recording and detection methods improve; the imposition of the synchronization event should be accounted for accordingly. Those skilled in the art will understand this, and also that the invention contemplates such changes.

A second advantage of limiting the number of pixels, audio frequencies or the magnitude of the change in pixels or audio frequencies, is that smaller changes are also easier to undo in the event that restoration of the audio and video signals to the original state (before the events were added) is desired.

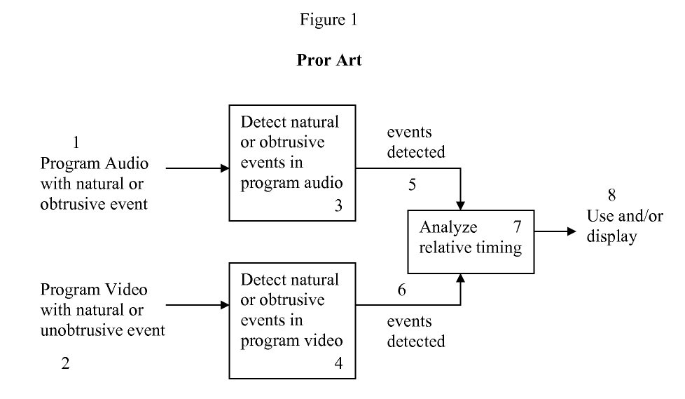

FIG. 1 shows system that detects corresponding naturally occurring audio and video synchronization events in the audio and video signals of a program when those events might occur. Since it is probable that those corresponding events originated at the same time, the relative timing of the detection of the events is analyzed by the system to determine the relative timing of those audio and video signals. On example of such a natural event synchronization system is shown in U.S. Pat. No. 5,572,261 of J. Carl Cooper. For example, this patent teaches inspecting the opening and closing of the mouth of a speaker, and comparing that opening and closing to the utterance of sounds associated therewith. The system however relies on the presence of such events (which can vary randomly and indeed may be absent when needed, and the accuracy also relies on the proximity of the microphone. Here microphone placement is critical because the microphone receives the audio event, which is used to match up with the image of the subject creating the sound corresponding to that event.

As FIG. 1 shows, program audio (1), which may have a natural or obtrusive event, is coupled to audio event detector device (3) that detects event(s) in the program audio. An audio event detected signal (5) is output from device (3). Similarly, program video (2); which may have a natural or obtrusive event, is coupled to video event detector device (4) that is configured to detect event(s) in that program video. A video event detected signal (6) is output from device (4). Event detected signals (5) and (6) are then operated on to analyze relative timing by relative timing analysis device (7), which in turn outputs a signal (8) responsive to the relative timing of events (1) and (2).

As previously discussed, the problem with unobtrusive prior art systems that rely upon natural synchronization events, such as the system shown in FIG. 1, is that they are not always reliable. They rely upon chance correlations between audio and video signals, such as opening and closing of a speaker's mouth, which may not always be relied upon to provide enough information to allow audio and video signals to be adequately synchronized under all conditions. As an example, consider a situation where video is intercut between a sports game shot with a long distance lens, and an announcer talking. If the announcer for some reason does not immediately start talking after a scene shift, prior art systems that rely upon naturally occurring audio and video synchronization events may be unable to adequately synchronize audio and video during natural periods of inactivity in the video.

Although other prior art “artificial event” or “synthetic event” systems, such as the previously discussed “clapboard” or pop/flash signals, would be able to synchronize the audio and visual material in a television program with multiple cuts, these prior art artificial events will be highly disruptive. The many pops and flashes and clapboard motions will significantly detract from the viewer enjoyment of the program.

Thus neither type of prior art—audio/video synchronization methods, whether synthetic, overt, or randomly occurring natural events, is entirely satisfactory in all situations.

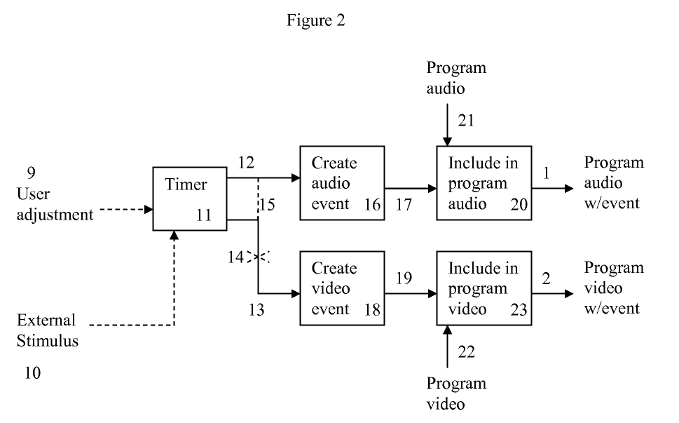

FIG. 2 shows an example of an “unobtrusive synchronizer” device configured according to one embodiment of the invention. Essentially, this embodiment functions by providing frequent synthetic but non-obtrusive audio video synchronization signals, typically every few seconds. As previously discussed, these non-obtrusive signals are designed to be intense enough to be reliably detected by automated equipment designed for this purpose, but unobtrusive enough as to not detract from the viewer's enjoyment of the program. According to the invention, these events may be unobtrusive enough to be either dismissed by the viewer as background audio and visual noise; or may be completely undetectable by human viewers; or, alternatively, may be unobtrusive enough so as to be capable of being effectively subtracted from the final signal by automated audio and visual signal processing equipment.

Still referring to FIG. 2, in this embodiment of an “unobtrusive synchronizer”, a timer (11) is used to periodically generate an audio event signal (12) and a video event signal (13). The signals (12) and (13) may be simultaneously generated, or may be generated with known timing differences. In the event it is desired to utilize simultaneous timing, a single signal may be utilized as shown by alternate configuration (14) and (15), in which a single signal (12) is shunted by (15) to also trigger the video event (18) as well as the audio event (16).

The timer (11) may operate with an internal timing reference, and/or with an alternate user adjustment (9) and/or with an external stimulus (10). In the embodiment illustrated, timer (11) is configured to output events on (12) and (13), and these signals are coupled to a “create audio” device or event block (16) and a “create video” device or event block (18) respectively. When “create audio” device (16) receives an event via (12) it creates an audio event (17). The audio event (17) is included in the program audio (21) by device or program audio pickup (20) to provide the program audio with event signal (1). When “create video” device (18) receives an event via (13), it creates a video event (19). The video event (19) is included in the program video (22) by device or video camera (23) to provide the program video with event signal (2).

Although not shown in FIG. 2, the creation of audio events (17) and video events (19) may be responsive to the audio and video signals and/or other program related characteristics as discussed below such that the characteristic (e.g. type) of event and timing of the insertion of the event is responsive thereto in order to minimize the viewer perception of the added event.

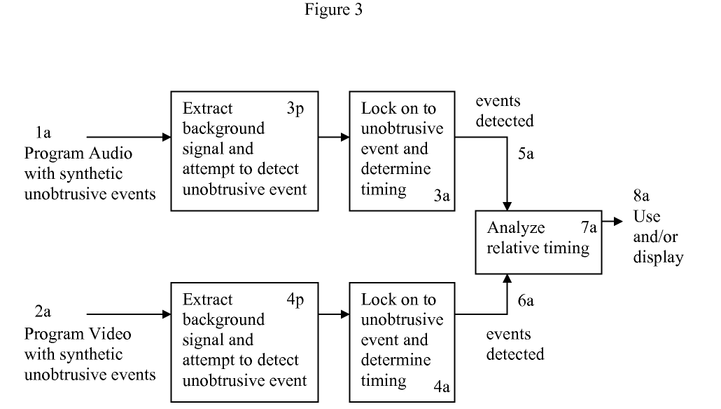

Once incorporated into the program audio and video, audio event (1) and video event (2) may be transmitted, processed, stored, etc. and subsequently coupled to an improved and novel audio visual synchronization analyzer, shown in FIG. 3. Here, the difference between the improved audio visual synchronization analyzer shown in FIG. 3 and the conventional audio visual synchronization analyzer (shown in FIG. 1) is that, in the prior art analyzer, either natural unobtrusive synchronization events (such as the correspondence between mouth position and the audio signal) or obtrusive events (clapboards or flash/blip devices) were used.

By contrast to prior systems and methods, in the present invention, synthetic unobtrusive synchronization signals are used. These typically will require different analytical equipment than the mouth position analyzers and flash analyzers of the art. According to the invention usually, the audio and video analysis devices of the present art can be optimized to detect low level (inconspicuous) event signals that are hidden in the dominating audio and video program signals, and are optimized to report when these low-level event signals have been detected.

To do this, the improved and novel device shown in FIG. 3 may have additional signal analysis preprocessing devices (3p), (4p), that analyze the overall audio and video signal, and attempt to determine the presence or absence of a relatively minor (unobtrusive) pattern that is characteristic of a synchronization event. Once the presence of this minor (unobtrusive) pattern has been established, preprocessing devices (3p), (4p) can then report the presence or absence of this pattern to other devices (hardware or software) (3a), (4a) that lock on to this minor (unobtrusive) signal, and use this signal to establish event timing. Some specific examples of such devices (3p) and (4p) will be discussed below.

Note that in one embodiment, the audio events and the video events used for audio and video synchronization are preferred to be incorporated into the actual program audio and actual program video respectively, as opposed to being incorporated into different audio or video channels or tracks that do not contain program information or in non-program areas (e.g. user bits or vertical blanking). Thus a video camera or device designed with an input to receive create a video event signal (19) and to merge this event with the program video (22) using a video camera (23) will in fact incorporate a video event signal (19) into the portions of the program video signal that contain useful image information. Similarly, an audio recorder or transmitter or other device designed with an input to receive create audio event signal (17) into portions of the program audio signal (21) by audio recording or transmitting device (20) will in fact incorporate audio event signal (17) into the portions of the program audio signal that contain useful audio information. By incorporating the audio and/or video event signal in the actual program audio and/or video signal the possibility of the event signal being lost due to subsequent audio and/or video signal processing is minimized. In addition, incorporating the audio and/or video event signal in the actual program audio and/or video may be accomplished optically (for video) or audibly (for audio) by adding suitable stimulus in the vision field of the camera and audible field of the microphone which are utilized to televise the program.

Thus, by using the improved audio video synchronization analyzer (FIG. 3) configured according to the invention, the particular known unobtrusive audio and video synchronization events (17) and (19) are detected by (3p)+(3a) and (4p)+(4a) respectively. Those detected events can be analyzed to determine their relative timing by (7a). This is one example of a system configured according to the invention and is not intended to in any way limit the scope of the invention, as defined by the appended claims.

Returning to FIG. 2, event timer (11) may operate with or without external controls (9) and stimulus (10). In one embodiment, the event timer may output a video event on (13) followed 100 ms later by a corresponding audio event on (12). This may be repeated every 5 seconds. Many other schemes are possible, however. If desired, the generation of the events on (13) and (12) may also be performed in response to an external stimulus such as abrupt changes in the audio or video input (10). Thus in this example, the timer might emit a event (12), (13) every five seconds in the absence of abrupt changes in the audio or video input, but might also emit an additional event (12), (13) in response to an usual sound or image change or other stimulus is detected (10). While the external stimulus may be detected in response to audio or video, it may be detected in other manners as well, or example in response to the production of the program.

In an original production situation such as the original recording or broadcast of a program from a television studio or other location, the external stimulus, and thus the inserted video event, may be responsive to changes in the camera frame or changes in the selected camera. For example it is preferred that when a camera zoom is changed resulting in a change of the vertical height of the image of more than 2:1, or a pan or tilt resulting in a change of more than 50% of the viewed scene, or a selection of a different camera which provides the video image, a stimulus (10) be generated thereby causing the insertion of events in the audio and video. Detection of these scene changes are preferred to be responsive to positional sensors in the camera itself and in response to the selection of particular cameras in a video switcher (for example via tally signals) but alternatively may be in response to image processing circuitry operating with the video signal from the camera.

Changes in audio may be utilized as well to provide external stimulus to which the audio events are responsive. For example it is preferred to generate external stimulus in response to a change in selection microphone which provides program audio, such as selecting the microphone of a different person who begins speaking on the television program. It is preferred that such changes be detected in response to the mixing of the audio signal in an audio mixer, for example in response to switching particular microphones on and off.

The events may be inserted in the audio and video either before the change takes place in the audio and video (requiring the audio and video to be delayed with the insertion occurring in the delayed version) or after the change takes place in the audio and video, or combinations (e.g. in audio before and video after or vice versa). It is preferred that event insertions be made in audio and video one to three seconds after the change. The amount of delay of event insertion may be user adjustable or audio or video signal responsive so as to minimize the noticeability to the viewer as described below. It will be understood that the mere fact of adding the inserted events to audio and video, either optically or electronically, within one to three seconds after such change will itself cause the inserted events to be masked by that change.

It is also possible for a user to adjust the rate or timing of generation of events (13) and (12) via automated or manual user adjustment (9). For example, in programs, like sports programs, where the potential for large or sudden changes in audio or video signal processing is high (due for example to the difficulty of compressing scenes with a lot of detail and motion), the speed (rate of generation of synthetic unobtrusive audio and video synchronization events) may be manually or automatically increased to facilitate quick downstream analysis of audio to video timing. For programs like talking heads, where the potential for large or sudden changes in audio or video signal processing is relatively low, the rate may be slowed. The inserted video event characteristic and/or timing may be adjusted by an operator in response to the type of video program (e.g. talking head or fast moving sports) or with the operator making manual adjustments according to the current scene content (e.g. talking head or fast sports in a news program). It is preferred however for video image processing electronics to automatically detect the current scene content and make adjustments according to that video scene content and video image parameters which are preprogrammed into the electronics according to a desired operation. Similarly, the inserted audio event characteristic and/or timing may be manually or automatically adjusted to reduce the audibility or otherwise mask the audio with respect to human hearing while preserving electronic detection.

Adjustment of inserted audio and video event characteristic is preferred to be responsive to the audio or video respectively such that it maintains a high probability of downstream detectability by the delay determining circuitry but with a low probability of viewer objection. It is preferred that in fast changing scenes the video event contrast relative to the video be increased as compared to slowly changing scenes. It is preferred that with noisy audio program material that the audio event loudness be increased relative to quiet audio program material. Other changes to the characteristics of the inserted events may be resorted to in order to optimize the invention for use with particular applications as will be known to the person of ordinary skill in the art from the teachings herein.

The unobtrusive audio and video synchronization information events may be placed onto the program audio and program video in a number of different ways. In one embodiment, this information may be done by sending the signals from the unobtrusive audio and video synchronization generator to the audio and video program camera or recorder by electronic means.

In this embodiment, devices (20) and (23) may be audio and video sensor (microphone, video camera) or pickup devices that incorporate unobtrusive audio and video event generators (16), (18) as part of their design. These modified audio and video sensor devices may operate in response to electronic unobtrusive audio and video synchronization signals being applied via (12) and (13), for example by direct electronic tone generation, or direct video pixel manipulation, by unobtrusive event creators (16), (18) that form part of the audio and video sensor device.

However, for this method, the audio device and video pickup device (microphone and camera) may need to be designed to specifically incorporate inputs (12) and (13), as well as unobtrusive event generators (16) and (17). Thus, general methods that can work with any arbitrary audio device and video camera, rather than an audio device and video camera specifically designed to incorporate inputs (12)+device (16) or inputs (13)+device (18), are desirable.

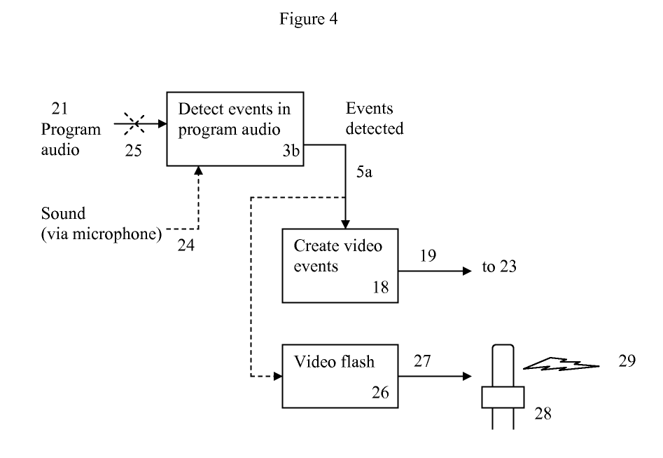

To do this, methods are required to transduce the unobtrusive audio and video synchronization signals (12), (13) into unobtrusive audio and video signals. These can in turn be detected by arbitrary audio and video input devices. One example of a device that can do this is shown in FIG. 4, another embodiment of the inventions.

FIG. 4 shows an embodiment of the invention that picks up audio events that are naturally expected to be present in the program audio, optionally supplements these events with additional artificial timer events (not shown), and complements the natural audio events and optional timer events with synthetic unobtrusive video events. This produces a synchronized natural audio event in addition to a synthetic video event that can be used for later audio and video synchronization.

In this embodiment, program audio (21) is coupled to audio detection device (3b) where particular natural events in the program audio are detected. Alternatively, a separate microphone, e.g. a microphone not normally used to acquire program audio (21), may be utilized to couple sound from or related to the program scene to device (3b) as shown by the alternate connection indicated by (24) and (25). Device (3b) analyzes the sound for preselected natural audio events, and generates an audio event signal (5a) when the natural audio signal meets certain preset criteria.

In one embodiment, the events which are detected by device (3b) are known levels of band limited energy that occur in the sound of the televised scene. As one example, this audio energy may be a 400 Hz signal, and may be detected by a band limiting filter centered at 400 Hz with skirts of 20 dB per octave. In this particular example, the occurrence of an increase or decrease of energy which is at least 9 Db above or below the previous 5 second average of energy is useful.

In this example, when such occurrence is detected by device (3b), device (3b) may emit a short audio event detection event (5a) having duration of, for example, 2 video frames.

In response to the audio event detection event (5a), a video event (19) is created by a video event creation device (18) or an alternative visual signal producing means such as the video flash production device shown in (26), (27) and (28).

If a video event creation device (18) is utilized, it will operate to create a video event (19) which is coupled to a device (23) that incorporates the signal into the program video signal, as shown in FIG. 2. For example, this could be a video camera with an input jack, infrared receiver, radio receiver or other signal receiving means which receives signal (5a), or it could be an electronic signal processing device that alters the video signal. Once received, the video event creation device electronically includes the video event into the program video by non-obtrusive means, such as by altering the state of a small number of pixels on the corner of the video image, altering low order video pixel bits, or other means.

Alternatively, audio event detection event (5a) may be coupled to a visual signal producing device, such as a video flash circuit (26). This video flash circuit or device (26) can create a light signal, such as an unobtrusive light flash event (27) to drive a light emitting device (28) to generate an unobtrusive flash of light.

In one embodiment, video flash circuit (26) is an LED current driver which drives current (27) through a high intensity LED (28) to create an unobtrusive event of light (29). The LED (28) is preferred to be placed in an out of the way area of the program scene where the light (29) is picked up by the camera which is capturing the scene, but where the light does not distract the viewer's attention away from the main focus of interest of the scene.

It is preferred that the event of light appear to the viewer simply as a point of intermittent colored light reflection from a shiny object in the televised scene. For example a small table lamp which appears as part of the televised scene, having a low intensity amber bulb appears to have a dangling pull chain which intermittently reflects a flash of yellow light from the bulb. In reality the flash comes from a yellow LED (28) at the end of the pull chain which intentionally flashes yellow light (29) in response to (26). The intensity, timing and duration of the flash may be modified in response to the particular camera angle and selection of camera as described herein. Of course the entire (lamp and LED) image may be generated and inserted in the scene electronically by operating on the video signal, as compared to having an actual instrument (lamp with LED) in the scene.

Downstream, it is preferred to utilize image processing electronics to inspect the video signal, locate the location of the LED on the lamp and detect the timing of the flashes of light therefrom.

In addition to the 400 Hz event previously mentioned, other types of audio signals may also be used to create a useful audio event. In fact, one of ordinary skill in the art will know from the teachings herein that many other events may be also detected and utilized as may be desired to facilitate operation of the invention in a particular system or application. Additionally multiple events may be utilized and may be utilized with various frequency, energy, amplitude and/or time logic to generate desired video events as may be desired to facilitate operation of the invention in a particular system.

Similarly, in addition to the LED output means used to create a corresponding video event, one of ordinary skill in the art will know from the teachings herein that other actual or electronically generated image events may also be utilized as desired to facilitate operation of the invention in a particular system or application. Additionally multiple video events may be utilized. For example, different color light(s) may be generated, or lights in different positions may be utilized, or movement of objects in the program scene may be used.

The method of generating the video event may also change, for example any known type of light generating or modifying device may be coupled to the create video event signal (19) and may be utilized. Examples of such light generating devices include, but are not limited to, incandescent, plasma, fluorescent or semiconductor light sources, such as light emitting diodes, light emitting field effect transistors, tungsten filament lamps, florescent tubes, plasma panels and tubes and liquid crystal panels and plates. Essentially, the light output may be of any type to which any sensor in the camera responds, and thus could also be infrared light which may not be detected by human eyes, but which may be detected by camera image sensors.

Mechanical devices may also be utilized to modify light entering the camera from part or all of the program scene, for example one or more shutter, iris or deflection optics may also be utilized.

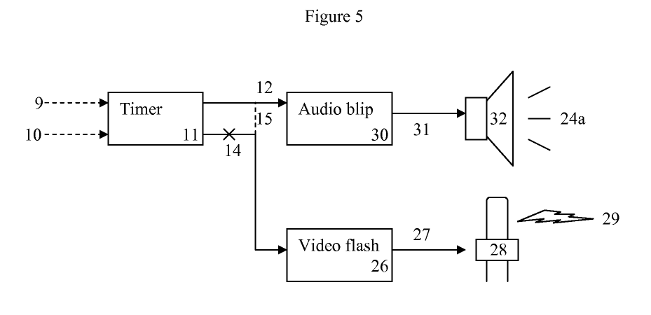

FIG. 5 shows yet another embodiment of the invention. In this embodiment, timer (11) (which may optionally be responsive to user adjustments (9) and external stimulus (10) previously described in respect to FIG. 2) provides either separate audio event signals (12) and video event signals (13) (or alternatively only a combined audio and video event signal (12) as shown by (14) and (15)). The video portion of the video event signal is coupled to a video flash circuit (26) which sends power or an activation signal to a video output device such as an LED (28), generating an unobtrusive light output signal (28).

FIG. 5 also shows an audio blip circuit (30) responsive to the audio event signal (12). The audio blip circuit (30) provides an audio blip signal (31) which drives an acoustic device (32) such as a speaker to generate unobtrusive sound (24a). Many types of audio signals may be used. As one example, it may be preferred that the audio blip circuit (30) include a tone generator for generating an electronic tone signal (31) having a duration of 250 ms, with the tone signal driving a speaker (32) to generate a sound of 400 Hz which at a level which causes program audio 1 to carry the 400 Hz tone at a level 20 Db below the 0 VU (0 volume units) program audio, as is known in the art.

One of ordinary skill in the art will understand from the present teachings that other frequencies (including pulse, chirp and swept), durations and acoustic levels also may be resorted to, and used to facilitate use of the invention in a particular system or application.

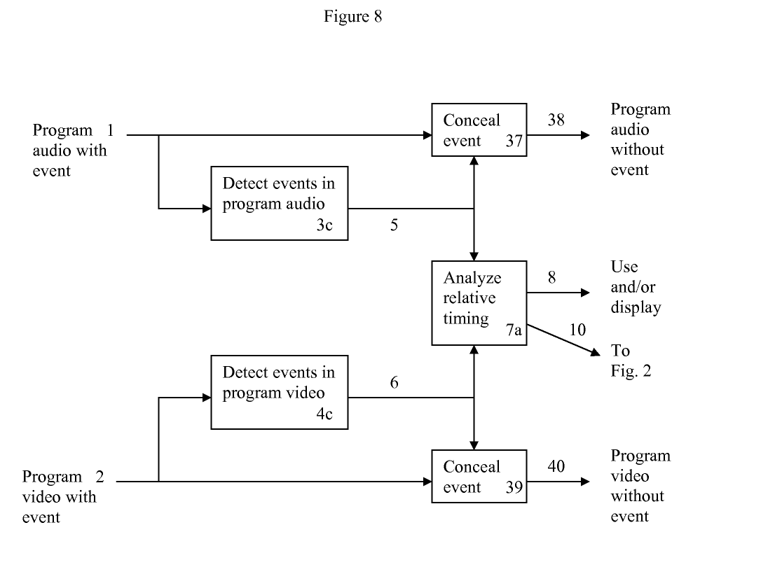

Consequently, the device shown in FIG. 5 will operate to provide unobtrusive sound (24a) and light (29) events which are picked up by the microphone(s) and camera(s) respectively which are used to capture the program. The unobtrusive sound and light sources (32) and (28) may be located within the scene, and take on characteristics, such as intensity and duration, which make them unnoticeable to the downstream viewer. (Alternatively the sound and light events may be detected and then electronically removed from the program audio and video signals as will be described in more detail in FIG. 8).

Importantly, the sound and light events that are generated are also captured by the program microphone(s) and camera(s) and carried by magnetic, electronic or optic signals or data as part of the actual program. Because these events are generated at known times and in known relationship, the subsequent detection of these events is facilitated and the events may be subsequently removed from the signals or data. One of ordinary skill will recognize from these teachings that the invention has several advantages over the prior art, including but not limited to, guaranteeing that events are placed in the image and sound portions of the program and may be placed in those portions in a manner which is independent of how the program is recorded, processed, stored or transmitted. In addition, the sound event may be adapted to special needs such as where the program microphones are not located near the program sound source. Such adaptation may be accomplished for example by placement of the location of sound source (32) relative to the microphone(s) used to acquire program audio or relative to the program sound source.

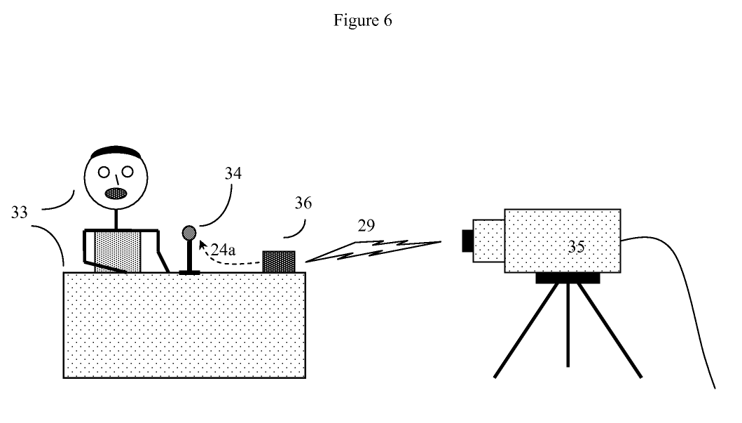

FIG. 6 shows a typical utilization of the present invention in respect to a common program scene with a set (33), in this instance including an actor, has a microphone (34) located near the sound source (the actor) and this microphone is utilized to acquire the program audio. The program scene images are acquired with a camera (35). The unobtrusive audio and video synchronization invention (36) previously shown in FIG. 5 is located near the microphone (34) and emits audio events (unobtrusive low level noises) (24a) which are picked up by the microphone (34). At roughly the same time, device (36) emits unobtrusive video events (small unobtrusive spots of colored light, such as blue light) (29) which are picked up by the camera (35).

As previously shown in FIG. 5, the audio and video synchronization device (36) has sound emitting and light emitting devices (32) and (28) which emit the unobtrusive audio and video events respectively. The actual location of the sound and video emitting devices (32) and (28) do not actually have to be located in the chassis of device (36), but rather may be located and configured to facilitate use of the invention with a particular program, system or application. Sound and light emitting devices (32) and (28) will be controlled by device (36), but may be connected to device (36) by electrical wires, radio links, infrared links, or other types of data or power transmission links.

For example with television cameras, the light emitter (28) may be located within the scene or may be located in the optical path of the camera (35) where it is situated to illuminate one or a small group of elements of one or more CCD sensors, preferably in one of the extreme corners. In this fashion the subsequent detection of the video event may operate only to inspect only those elements of the corresponding image signal or file which correspond to the CCD element(s) which may be illuminated. In another embodiment, light source (28) and (29) may be located such that it illuminates the entirety of one or more CCD sensors, thereby raising the black level or changing black color balance of the corresponding electronic version of the scene during illumination, or it may be located so as to raise the overall illumination of the entire scene (33) thereby increasing the brightness of the corresponding electronic version of the scene. Illumination of individual red, green or blue camera sensors may also be accomplished by locating light emitting source (28) and (29) in a fashion such that only that the desired sensor is illuminated, or by utilizing red, green or blue sources (28). Combinations of colors may be utilized as well.

Alternatively the microphone may be plugged into an audio blip (event) generation device (audio event generating box) and the audio event added by direct electronic means. Similarly the video camera may be plugged into a video event generation device (video event generating box) and the video event added by direct electronic means.

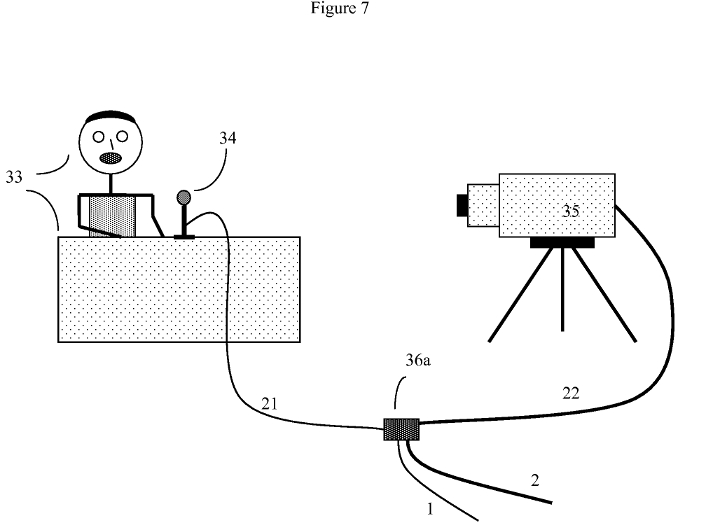

In another embodiment, shown in FIG. 7, a combination device (audio and video event generating box) (36a) may be produced with inputs for both audio signals (21) (microphones) and video (camera) signals (22). This combination device (audio and video event generating box) (36a) may have a design similar or identical to that previously discussed in FIG. 2, and may optionally contain its own timer and user inputs, and automatically and electronically insert audio events and video events into the input (21), (22) signals. The combination device may have audio inputs and video inputs to receive input from microphones (34) and video cameras (35), and audio and video outputs to send the modified audio and video signals (audio and video signals plus events) (1), (2) to downstream broadcast or recording equipment.

FIG. 8 shows an alternative version of the improved audio video synchronization analyzer previously shown in FIG. 3. The device shown in FIG. 8 also performs audio and video synchronization with unobtrusive audio and video signals, and it additionally acts to subtract these unobtrusive audio and video synchronization signals from the program audio and video output. This produces both the synchronization information and an audio output and video output where the audio and video synchronization signals have been reduced down to a level that is essentially undetectable by the average viewer.

In this example the known unobtrusive audio event provided by (16) and (20) of FIG. 2; or (30) and (32) of FIG. 5, can be produced by device (36) as seen in FIG. 6. This unobtrusive audio event (24a) is in turn detected by a sound detection means, such as the microphone (34) and in turn is transmitted over the audio portion of the program. On the receiving end, the audio portion of the program is received, and analyzed by the improved audio video synchronization analyzer for useful audio and video synchronization signals. In this example, the unobtrusive audio event is a short and low level tone that the average person might easily ignore, but which might over time become irritating to viewers who are aware of such synchronization tones, and know what they sound like. Thus removal of this event tone after it has been used for audio and video synchronization is desired.

Returning to FIG. 8, in this example, the unobtrusive sound event (FIG. 6 (24a)) has been transmitted, and is now received as the program audio with the event (1). The unobtrusive audio event (24a) encoded in the program audio with the event (1) is then detected by the audio event detector (3c). The unobtrusive audio event then generates an audio event signal (5). The audio event signal (5) is coupled to the relative timing analyzer device (7a) and provides the audio portion of the audio and visual inputs needed by timing analyzer (7a) to determine audio and visual timing.

In one embodiment, audio event detector (3c) operates much as does audio event detector (3p)+(3a) previously shown in FIG. 3, and detects an unobtrusive frequency (400 Hz), and loudness (9 dB above or below average) of the audio marker by conventional means known to those of ordinary skill in the art. Alternatively, if the audio marker results from use of the system of FIG. 4, audio event detector (3c) would detect a different unobtrusive 400 Hz tone, 20 dB below 0VU, having a duration of 250 ms. Other audio markers are also possible.

FIG. 8 also shows program video with event(s) (2). These events are unobtrusive video events, which are typically produced by video event devices (18) and (23) of FIGS. 2 & 4, or video flash devices (26) or (28) of FIG. 5. This is also shown in FIG. 6 (29). To make this example easy to visualize, assume that the unobtrusive video event (29) is a small blue flash that is on for two video frames and is then off again. This flash is unobtrusive in that a normal user would usually not notice it, but it is not undetectable. An experienced person might know where to look, and gradually become irritated by the blue light signal. Thus removal of the blue light signal during the broadcast is desired.

Here the unobtrusive video event (FIG. 6 (29)) has been transmitted, and is now received as the program video with event (2). Video event detector (4c) (equivalent to earlier devices (4p)+(4a) previously shown in FIG. 3), detects the unobtrusive video event (blue flash), and obtains the event signal (6). Event signal (6) is sent to the relative timing analyzer device (7a) and is used, in conjunction with the audio event signal (5), for audio and video time synchronization purposes (relative timing) in (7a).

Additionally, FIG. 8 shows the program audio is also coupled to an audio event conceal device (37). In this embodiment, audio event conceal device (37) is also responsive to audio event detection signal (5), and when device (37) receives this signal, it conceals the event in the program audio with event (1). As a result, the formerly unobtrusive audio signal (24a) is now reduced to an essentially undetectable level, thus providing program audio without the event (38). Audio event conceal device 37 may operate by various methods such as by applying a cancellation signal to the program audio with event signal (1) whenever audio event detection signal (5) indicates the audio event is present, thereby cancelling and eliminating (or substantially reducing) the event from the program audio.

Alternatively audio event conceal device (37) may operate in many other manners as will be known to the person of skill, as just one example by coupling the audio through a band reject filter during the time that audio event detection signal (5) indicates the presence of the audio event to thereby reject the audio event.

In a fashion similar to the audio event conceal device (37), the program video with event (2) is coupled to video event conceal device (39), thus reducing the unobtrusive video event to an essentially undetectable video event. The video event conceal device (39) receives the video event detect signal (6) and operates to conceal the video event to provide program video without the event (40).

Consider the example where the video event (29) appears as a small blue spot of light in the video image. When the video event detect (6) is active indicating the video event is present, the pixels of the frame(s) of video which take on this blue spot appearance can be changed to black, their normal state, or changed to some other less detectable color, for example blue subtraction can be done by filling in the blue pixels by interpolating the contents of the video pixels near the blue signal pixels.

In general, the event conceal devices 37 and 39 can essentially be viewed as active counterparts to the event detect devices (3c) [(3p)+(3a)] and 4c [(4p)+(4a)] in that the event conceal devices may modify the overall audio or video signal as to subtract from it the expected unobtrusive event pattern. Thus a positive unobtrusive event tone can be suppressed by either filtering the positive tone or applying a negative tone of opposite phase, and a positive unobtrusive event video signal can be suppressed by subtracting the event pixel pattern from the image pixels. Thus a blue light can be corrected by performing a blue color subtraction on the appropriate pixels, a black dot can be corrected by interpolating the colors from neighboring pixels, and so on.

In this embodiment, audio and video synchronization can be reliably maintained over a broad range of conditions using standard broadcast equipment, plus an audio video synchronization device such as FIG. 4, 5, or 6 (36) at the transmitting end, and an improved audio video synchronization analyzer at the receiving end. Using these methods, audio and video signals may be continually sent, but because the signals are designed to be unobtrusive, the signals can either be easily subtracted at the receiving end, or alternatively even when not subtracted will still not be objectionable to the average program viewer. Since the consequences of poor audio video synchronization—poor lip sync, is immediately apparent and is highly objectionable to the average program viewer, the net effect is a substantial improvement over prior art audio and video synchronization methods.

### Encoding Methods Useful for Digital Systems:

When digital audio or video signals are used, other unobtrusive event encoding methods are also possible. Usually this will be done by altering the least significant bits of the digital audio or video signal, such as the last bit or second to the last bit, taking into account the particular manner in which the signal is encoded to minimize the impact on the resulting signal. For example, a normal digital audio or video signal will consist of an array of numbers that describe the audio and video content of the signal, and this array of numbers will usually consist of a mix of even and odd numbers. It would be statistically very improbable that either the audio signal or the video signal consist of all even or all odd numbers. As a result, one very unobtrusive event encoding scheme that is also easy to detect is an encoding scheme in which some of or all of the contents of an audio signal or image are briefly rounded to the nearest odd or even value, thus resulting in a very improbable event of a sequence of digital video and/or audio signals composed of all even or odd numbers. However since the value of an audio signal or video signal that is changed from its original value by just one unit is likely to be undetected by a viewer of a program material; such a change may also be used to convey digital and audio synchronization events in an unobtrusive manner.

A specific example of this method is shown below:

In this specific example, it is assumed that the video signal is a simple digital signal of red, green, and blue colors, where each color has 8 bits of intensity resolution (0=black, 255=maximum intensity). In this example, the unobtrusive video event is encoded by altering the least significant bit of each pixel color, such as the blue color, to be rounded to the nearest even value during the unobtrusive video event, but not to be altered in any away at other times (when there is no such unobtrusive video event). If a number of neighboring pixels are analyzed by a device, such as device (4a) of FIG. 3, on a frame by frame basis (that is, every 1/30 or 1/60 second for normal American broadcast digital video) the following data might be found:

Values of six neighboring pixels in a non-interlaced video display, 1 frame every 30 seconds

| | | | | | Frame | Frame |
|---|---|---|---|---|---|---|
| | Frame −2 | Frame −1 | Event 1 | Event 2 | +1 | +2 |
| Pixel 1 | 160 | 160 | 160 | 160 | 160 | 160 |
| Pixel 2 | 141 | 141 | 140 | 140 | 141 | 141 |
| Pixel 3 | 130 | 130 | 130 | 130 | 130 | 130 |
| Pixel 4 | 129 | 129 | 128 | 128 | 129 | 129 |
| Pixel 5 | 110 | 110 | 110 | 110 | 110 | 110 |
| Pixel 6 | 101 | 100 | 100 | 100 | 101 | 101 |
| Even | 3 | 3 | 6 | 6 | 3 | 3 |
| Odd | 3 | 3 | 0 | 0 | 3 | 3 |
| Odd/Even | 1.0 | 1.0 | 0 | 0 | 1.0 | 1.0 |
| Ratio | | | | | | |

In this example, a video event encoder (18) has previously encoded an unobtrusive video event onto the video pixels by rounding the least significant digit of all bits to the next closest even value. The human eye would totally fail to see this change, and as a result, this change is essentially undetectable as well as unobtrusive.

The video event detector (4p) can still easily detect this unobtrusive video event however, if it is programmed or set with the information that in the absence of the video event, the average even/odd ratio of the least significant bits of the signal should be roughly 1:1 or 50:50. Detector (4p) analyzes the neighboring pixels, and determines that the pixels meet random criteria during frame −2 and frame −1 because the Odd/Even ratio of the pixels is about what would be expected for a normal unmodified video signal (3/3).

During the video event, however, the Odd/Even ratio of the pixels changes to 0/6. Although clearly more than six pixels would be needed for device (4p) to determine that an event has occurred beyond all shadow of a doubt, by the time that the number of pixels is much over 10-20, the chances of randomly picking up a false video event become very small.

A human viewer's eyes would not be sensitive enough to pick up the change, and thus this unobtrusive video event could be communicated thorough a normal digital video broadcast or recording system using standard equipment without disturbing human viewers.

Digital sound events can also be communicated in a similar manner by altering the even/odd bit patterns at various audio frequencies.

Alternative steganography (writing hidden messages in the audio or video portion of a signal), encoding methods may also be used to convey audio and video synchronization events. As in the previous example, however, typically the least significant bits of the audio or video signal may be manipulated to achieve statistically improbable distributions that can be readily detected by automated recognition equipment, such as the system of FIG. 3, yet remain undetected by the average viewer.

1. A method for unobtrusively sending audio and video time synchronization information over separate audio and video transmission or storage devices used to transmit or store time synchronized audio and video information comprising:
creating and time synchronizing unobtrusive audio events and unobtrusive video events wherein the synchronized unobtrusive audio and unobtrusive video events contain information pertaining to the relative initial timing of the time synchronized audio and video information;
incorporating the unobtrusive audio events and unobtrusive video events into the program audio and program video information that is transmitted or stored;
when the program audio and program video information is received or played back, reading the unobtrusive audio and the unobtrusive video events;
determining the subsequent timing of the unobtrusive audio events and unobtrusive video events; and
using this subsequent timing to provide information pertaining to the relative timing of the received or played back time synchronized audio and video information.

2. The method of claim 1, wherein the unobtrusive audio events and unobtrusive video events are created and time synchronized by an artificial timer.

3. The method of claim 2, wherein the artificial timer is controlled by external inputs selected from the group consisting of an external audio stimulus, an external video stimulus, user timing speed adjustments, and video compression amount adjustments.

4. The method of claim 1, wherein the unobtrusive audio events are audio sounds at a defined frequency for a duration of less than a second and with an intensity of less than 30 dB over the background sound intensity at the defined frequency.

5. The method of claim 4, wherein the unobtrusive audio events are sounds centered at 400 Hz with an increase or decrease of energy which is less than 30 dB above the previous 5 second average of energy at 400 Hz, but which is at least 9 dB above or below the previous 5 second average of energy at 400 Hz.

6. The method of claim 1, wherein the unobtrusive video events are changes in the light signal over less than 1% of the pixels in a video image, or a less than 1% change in the intensity signal of the pixels in a video image.

7. The method of claim 6, wherein the unobtrusive video events are created by light emitting or light altering devices selected from the group of incandescent, plasma, fluorescent or semiconductor light sources, light emitting diodes, light emitting field effect transistors, tungsten filament lamps, florescent tubes, plasma panels, plasma tubes, liquid crystal panels, and liquid crystal plates.

8. The method of claim 6, wherein the change in the light signal is a change that alters the color or average wavelength of the light signal.

9. The method of claim 1, in which the unobtrusive audio event or unobtrusive video event will not be detected by the average human viewer.

10. The method of claim 1, further removing the unobtrusive audio or unobtrusive video events from the received or played back program audio and program video information and then outputting either the received or played back program audio or program video information without the auto or video events.

11. A method for unobtrusively sending audio and video time synchronization information over separate audio and video digital transmission or digital storage devices used to transmit or store time synchronized audio and video information comprising:
creating and time synchronizing unobtrusive audio events and unobtrusive video events wherein the synchronized unobtrusive audio and video events contain information pertaining to the relative timing of the time synchronized audio and video information;
incorporating the unobtrusive digital audio events and unobtrusive digital video events into the program audio and program video information that is transmitted or stored;
and when the program audio and program video information is received or played back, reading the unobtrusive audio and the unobtrusive video events;
determining the subsequent timing of the unobtrusive audio events and unobtrusive video events; and
using this subsequent timing to provide information pertaining to the relative timing of the received or played back time synchronized audio and video information.

12. The method of claim 11, wherein the unobtrusive audio or video events are created by altering the lower significant bits of at least some of the audio or video information.

13. The method of claim 12, wherein altering the lower significant bits of at least some of the audio or video information is done by altering the lower significant bits to create a non-random bit distribution.

14. The method of claim 11, wherein the unobtrusive audio or video events are created by altering the least significant bit of at least some of the audio or video information.

15. The method of claim 11, further removing the unobtrusive audio or unobtrusive video events from the received or played back program audio and program video information and then outputting either the received or played back program audio or program video information without the auto or video events.

16. The method of claim 11, in which the unobtrusive audio event or video event will not be detected by the average human viewer.

17. A method to time synchronize audio and video signals, the method comprising;
creating synchronized audio and video events;
embedding the audio events in a program audio signal by audio steganography;
embedding the video events in a program video signal by video steganography;
storing or transmitting the audio or video signals;
analyzing the stored or transmitted audio signals and detecting the audio events;
analyzing the stored or transmitted video signals and detecting the video events; and
determining the time delay value between the audio events and the video events;
and using the time delay value to synchronize the audio and video signals.

18. The method of claim 17, in which the synchronized audio and video events are created by an automatic timer, and in which the automatic timer may optionally be controlled by external inputs selected from the group consisting of an external audio stimulus, an external video stimulus, user timing speed adjustments, and video compression amount adjustments.

19. A method for unobtrusively sending audio and video time synchronization information over separate audio and video transmission or storage devices used to transmit or store time synchronized audio and video information comprising:
creating and synchronizing unobtrusive audio events and unobtrusive video events, wherein the synchronized unobtrusive audio and video events contain information pertaining to the relative timing of the audio and video information;
incorporating the unobtrusive audio events and unobtrusive video events into the program audio and program video information that is transmitted or stored; and
subsequently reading the program audio and the program video information, determining the timing of the unobtrusive audio events and unobtrusive video events, and outputting information pertaining to the relative timing of the audio and video information.

20. The method of claim 19, in which the unobtrusive audio events and unobtrusive video events are created and synchronized using a timer.

21. The method of claim 20, further controlling the timer by external inputs selected from the group consisting of an external audio stimulus, an external video stimulus, user timing speed adjustments, and video compression amount adjustments.

22. The method of claim 19, in which the unobtrusive audio events are audio sounds at a defined frequency for a duration of less than a second and with an intensity of less than 30 dB over the background sound intensity at the defined frequency.

23. The method of claim 22, in which the unobtrusive audio events are sounds centered at 400 Hz with an increase or decrease of energy which is less than 30 dB above the previous 5 second average of energy at 400 Hz, but which is at least 9 dB above or below the previous 5 second average of energy at 400 Hz.

24. The method of claim 19, in which the unobtrusive video events are changes in a light signal over less than 1% of the pixels in the video image, or less than a 1% change in the intensity signal of the pixels in the video image.

25. The method of claim 24, in which the unobtrusive video events are created by altering the light output of light sources selected from the group of incandescent, plasma, fluorescent or semiconductor light sources, light emitting diodes, light emitting field effect transistors, tungsten filament lamps, florescent tubes, plasma panels, plasma tubes, liquid crystal panels, and liquid crystal plates.

26. The method of claim 24, in which the change in the light signal is a change that alters the color or average wavelength of the light signal.

27. The method of claim 19, in which the unobtrusive audio event or video event will not be detected by the average human viewer.

28. The method of claim 19, further concealing either the unobtrusive video or the unobtrusive audio events from the program audio and program video information after reading the audio and the video information, and then outputting either the program audio or the program video information without the unobtrusive auto or video events.

29. A method for unobtrusively sending audio and video time synchronization information over separate audio and video digital transmission or digital storage devices used to transmit or store time synchronized audio and video information comprising:
creating and synchronizing unobtrusive digital audio events and unobtrusive digital video events wherein the synchronized unobtrusive digital audio and digital video events contain information pertaining to the relative timing of the audio and video information;
incorporating the unobtrusive digital audio events and unobtrusive digital video events into the program digital audio and program digital video information that is transmitted or stored; and
subsequently reading the program digital audio and the program digital video information, determining the timing of the unobtrusive audio events and unobtrusive video events, and outputting information pertaining to the relative timing of the audio and video information.

30. The method of claim 29, wherein the unobtrusive audio or video events are created by altering the lower significant bits of at least some of the audio or video information.

31. The method of claim 30, wherein the lower significant bits of at least some of the audio or video information are altered to create a non-random bit distribution.

32. The method of claim 29, wherein the unobtrusive audio or video events are created by altering the least significant bit of at least some of the audio or video information.

33. The method of claim 29, further correcting the program digital audio or program digital video information for the distorting effects of the unobtrusive audio event or unobtrusive video event after the program digital audio and the program digital video information has been read.

34. The method of claim 29, in which the unobtrusive audio event or video event will not be detected by the average human viewer.

35. A method for creating unobtrusive audio and video time synchronization information, the method comprising;
taking program audio data from a program audio input; and program video data from a program video input;
with regular or variable timing, adding unobtrusive audio events to the program audio, and unobtrusive video events to the program video;
outputting the program audio with the unobtrusive audio events added;
outputting the program video with the unobtrusive video events added;
wherein the unobtrusive audio events and the unobtrusive video events may be used to time synchronize the program audio data and the program video data.

36. The method of claim 35, wherein the timing is varied depending upon data selected from the group consisting of an external audio stimulus, an external video stimulus, user timing speed adjustments, and video compression amount adjustments.

37. The method of claim 35, wherein the unobtrusive audio events are audio sounds at a defined frequency for a duration of less than a second and with an intensity of less than 30 dB over the background sound intensity at the defined frequency.

38. The method of claim 35, wherein the unobtrusive video events are a change in a light signal over less than 1% of the pixels in the video image, or a less than 1% change in the intensity signal of the pixels in the video image.

39. The method of claim 35, wherein the unobtrusive audio events alter at least some of the lower significant bits of a digital program audio signal; or wherein the unobtrusive video events alter at least some of the lower significant bits of a digital program video signal.

40. A method for reading unobtrusive audio and video time synchronization information encoded in time synchronized program audio and program video information, the method comprising;
receiving program audio with unobtrusive audio events;
receiving program video with unobtrusive video events;
the audio events and the video events existing with a defined time synchronization with each other;
detecting the audio events in the program audio;
detecting the video events in the program video;
analyzing the relative timing of the audio and video events;
and outputting a signal indicative of the timing difference between the time synchronized program audio and the program video.

41. The method of claim 40, further concealing the unobtrusive audio events in the program audio and/or concealing the unobtrusive video events in the program video, and outputting a modified version of the program audio and/or the program video in which the unobtrusive audio events and/or unobtrusive video events are now concealed.
